(19) United States
(12) Patent Application Publication
(10) Pub. No.: US 2006/0017988 A1
(43) Pub. Date: Jan. 26, 2006

(54) High-speed light sensing element for high-speed image scanning system

(75) Inventor: Ho-Min Chung, Taipei City (TW)

Correspondence Address: Welsh & Katz, Ltd.;Eric D. Cohen, 22nd Floor, 120 South Riverside Plaza, Chicago, IL, 60606, US

(73) Assignee: Lite-On Technology Corporation, Taipei (TW)

(21) Appl. No.: 10/972,525

(22) Filed: Oct. 25, 2004

(30) Foreign Application Priority Data
Jul. 23, 2004 (TW) 93122138

(51) Int. Cl. H04N 1/04

(52) U.S. Cl. 358/518; 358/486

(57) ABSTRACT

A high-speed light sensing element for a high-speed image scanning system is provided to sense light source of images. The element includes N light-sensing cells, N color signal processing units, N buffers and a synchronous processing unit. The light-sensing cells are used for sensing an image in a sensing area and outputting the sensed image data. The color signal processing units processes the corresponding image data. The buffers store the R, G, B, colors outputted from corresponding color signal processing units. The synchronous processing unit receives the color signals from the buffers and synchronizes the color signals.

This Non-provisional application claims priority under 35 U.S.C. § 119(a) on Patent Application No(s). 93122138 filed in Taiwan on Jul. 23, 2004, the entire contents of which are hereby incorporated by reference.

### BACKGROUND OF THE INVENTION

1. Field of Invention

The invention relates to a high-speed light sensing element and, in particular, to a high-speed light sensing element for high-speed image scanning for an image scanning device.

2. Related Art

With continuous improvement in the hardware and software techniques in image scanning devices, almost all image scanning devices nowadays can achieve a certain scanning quality (i.e., certain resolution). They have been satisfying the image scanning required by ordinary people and even professionals. As shown in FIG. 1, the conventional image scanning system consists of a light sensing element 100, an analog/digital (A/D) converter 110, an application specific processing unit 120, and a memory 130. To scan an image, the light sensing element 100 extracts an analog signal of an external image. The analog signal is output in terms of the RGB color signals. The A/D converter module 110 then converts the received analog signal into a digital signal for the application specific processing unit 120 for further processing. The processed digital signal is stored in the memory 130 for outputting to a processing terminal 150 via an interface converter 140 at an appropriate time.

The application specific processing unit 120 (usually called an ASIC, application specific integrated circuit) performs basic operations on the digital signal of an image. It normally contains: (1) a data gate 121 and an image processing unit 122 for image processing; (2) a buffer unit 123 for temporarily holding data for image processing; (3) an output recombination unit 124 for sorting the image signal; and (4) a transmission interface 125 for outputting the image signal. The operations and relations of the various components in the application specific processing unit 120 are well-known and thus not repeated herein.

From the above description, it can be seen that the operation of the conventional image scanning system is step by step. That is, there is a one-to-one relation among the light sensing element 100, the A/D converter module 110, and the memory 130. The analog signal output by the light sensing element 100 is sent to one A/D converter module to perform signal conversion. The digital signal processed by the application specific processing unit 120 is stored in one memory 130.

However, this kind of step-by-step processing mode is the primary bottleneck in the scanning speed of all image scanning devices. Therefore, it is imperative to find a new image scanning device having a higher image scanning speed without sacrificing the already satisfactory scanning quality.

### SUMMARY OF THE INVENTION

In view of the foregoing, an object of the invention is to provide a high-speed image scanning element for a high-speed image scanning system.

To achieve the above object, the disclosed high-speed image scanning element detects an image light source, where the image light source is divided into several sensing areas. Several sets of color signals are output for each of the sensing areas. The image scanning element includes: N light-sensing cells, N color signal processing units, N buffers and a synchronous processing unit. The light-sensing cells are used for sensing an image in a sensing area and outputting the sensed image data. The color signal processing units processes the corresponding image data. The buffers store the RGB color signals output from the corresponding color signal processing units. The synchronous processing unit, connected to the N buffers, receives the color signals from the buffers and synchronizes the N color signals.

According to the invention, the disclosed high-speed sensing element can first divide the scanned image data and then process them in parallel, thereby increasing the image processing speed.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description for serving to explain the principles of the invention, in which

FIG. 1 is a schematic view of a conventional image scanning system;

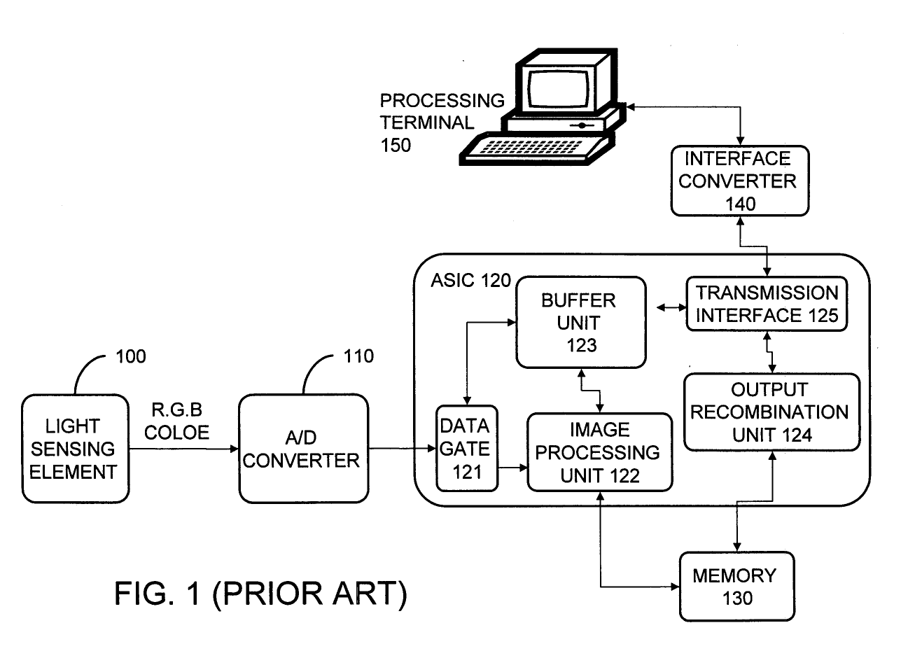

FIG. 2 is a circuit block diagram of the disclosed high-speed light sensing element; and

FIG. 3 is a schematic view of an embodiment of the invention.

### DETAILED DESCRIPTION OF THE INVENTION

Reference will now be made in detail to the preferred embodiments of the present invention, examples of which are illustrated in the accompanying drawings.

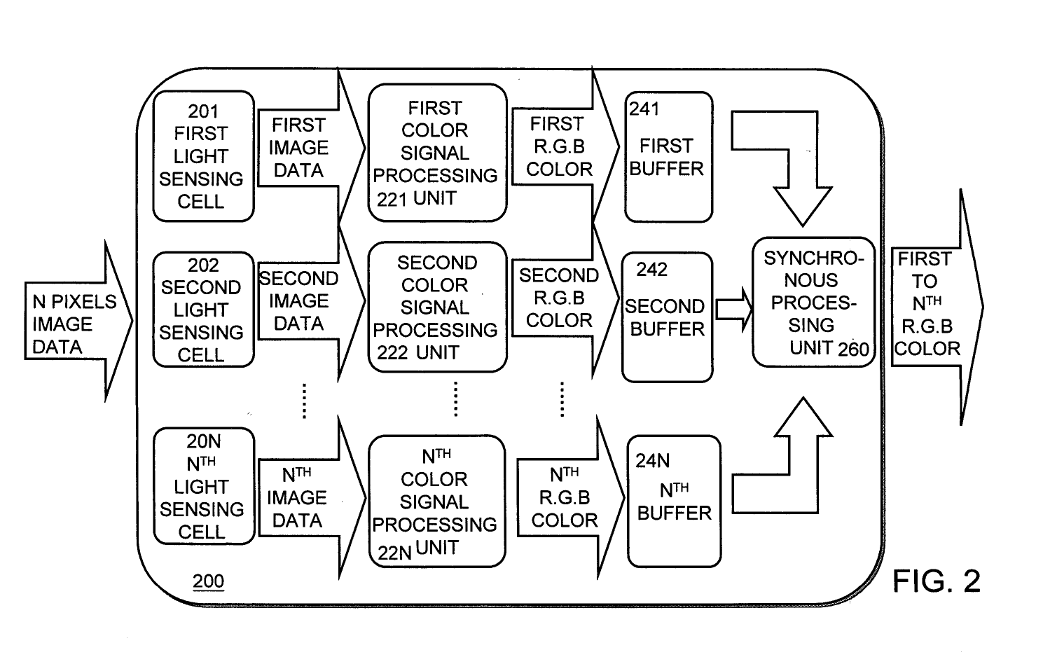

With reference to FIG. 2, the disclosed high-speed light sensing element is used to sense an image light source. The image light source is divided into several sensing areas. The high-speed light sensing element outputs several color signals for each of the sensing areas. The high-speed light sensing element contains: N light sensing cells (e.g., the first light sensing cell 201, the second light sensing cell 202, . . . , the Nth light sensing cell), N color signal processing units (e.g., the first color signal processing unit 221, the second color signal processing unit 222, . . . , the Nth color signal processing unit 22N), N buffers, and a synchronous processing unit. The light-sensing cells are used for sensing an image in a sensing area and outputting the sensed image data. The color signal processing units processes the corresponding image data. The buffers store the RGB color signals output from the corresponding color signal processing units. The synchronous processing unit is connected to the N buffers, receives the color signals from the buffers and synchronizes the B color signals for output. We describe the above components in detail as follows.

When detecting a document, the scanning device is set with a predetermined number of scanning pixels, and the scanned document is output using the predetermined pixels. The scanning device further divides the document, i.e., the scanning light source, into several sensing areas. When the scanning device scans the document sequentially, the plurality of light sensing cells arranged in the scanning device detects each of the sensing areas and produces corresponding image data.

For example, when the scanning device scans the document using several sensing areas (e.g. from the first sensing area to the Nth sensing area), each of the sensing areas is provided with a corresponding light sensing cell. More explicitly, the first sensing area is provided with a first light sensing cell 201, and the second sensing area is provided with a second light sensing cell 202, and so on. By dividing the image light source into several sensing areas and detecting them using different light sensing cells, the invention can achieve the goal of high-speed scanning.

Therefore, the first light sensing cell 201 outputs the first image data of the corresponding sensing area, the second light sensing cell 202 outputs the second image data of the corresponding sensing area, and the Nth light sensing cell outputs the Nth image data of the corresponding sensing area. All of the image data is sent to the corresponding color signal processing unit to process, outputting RGB color signals. Therefore, the first color signal processing unit 221 receives the first image data, and the RGB color signals are then generated after being processed and stored in the first buffer 241. Similarly, the second color signal processing unit 222 receives the second image data, and the second RGB color signals are then generated after being processed and stored in the second buffer 242. The third color signal processing unit 223 receives the third image data, and the third RGB color signals are then generated after being processed and stored in the third buffer 243.

Because the signal processing speed of each color signal processing unit may be different from each other, the detected signals may be asynchronous so that the original image cannot be faithfully presented. Thus, the processed RGB color signals are first stored in buffers, and the synchronous processing unit 260 monitors the statuses of the RGB color signals stored in the first buffer 241, the second buffer 242, . . . , and the Nth buffer. Once they are all processed and stored in the buffers, the synchronous processing unit 260 reads out the RGB color signals stored therein and synchronizes them before outputting for the subsequent processing.

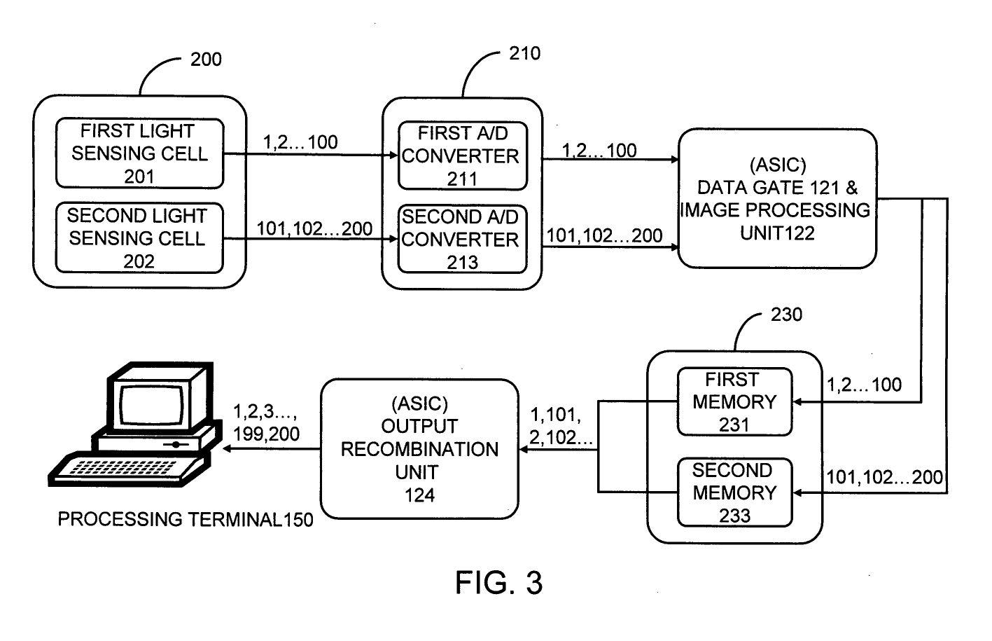

To show the feasibility of the invention, we give in the following an explicit embodiment, with reference to FIG. 3.

This embodiment assumes the following premises; that is, the image light source has 200 pixels. The high-speed light sensing element 200 has two light sensing cells (i.e., the first light sensing cell 201 and the second light sensing cell 202). The A/D converter module 210 has two A/D converters (i.e., the first A/D converter 211 and the second A/D converter 213), both of which are controlled by a converter control unit. The memory module 230 has two memories (the first memory 231 and the second memory 233), both of which are controlled by a memory control unit.

First, the first light sensing cell 201 and the second light sensing cell 202 of the high-speed light sensing element 200 simultaneously and evenly retrieve 200 image light source pixels. Therefore, the analog signals of the first to the 100^{th} pixels are processed and output by the first light sensing cell 201. Those of the 101th to the 200^{th} are processed and output by the second light sensing cell 202. (In this embodiment, each analog signal contains all the RGB color signals. Nevertheless, a different design of the high-speed light sensing element 200 can make each of the analog signals contain only one of the RGB color signals.)

Under the control of the converter control unit, the analog signal output by the first light sensing cell 201 is received by the first A/D converter 211. The analog signal output by the second light sensing cell 202 is received by the second A/D converter 213. All the analog signals are processed in parallel into digital signals and output to the application specific processing unit 120. (The first A/D converter outputs the digital signals of the first to the 100^{th} pixels, and the second A/D converter outputs the digital signals of the 101th to the 200^{th} pixels. However, the invention also allows the converter control unit to process in a non-one-to-one method.)

After the digital signals enter the application specific processing unit 120, both the data gate 121 and the image processing unit 122 process the digital signals. After being processed, the memory control unit distributes all the digital signals and store the signals to the first memory 231 and the second memory 233. (This embodiment adopts an even distribution. Therefore, the digital signals of the first to the 100^{th} pixels are stored in the first memory 231, and those of the 101th to the 200^{th} pixels are stored in the second memory 233. Nevertheless, an uneven distribution is also allowed.)

Finally, the memory control unit 127 sequentially retrieves the digital signals stored in the memories in order of 1^{st}, 101^{th}, 2^{nd}, 102^{t}h . . . . Then the signals are delivered to the output recombination unit 124 of the application specific processing unit 120 for sorting operation. After sorting operation, the image signals are arranged in the correct order, i.e., in order of 1^{st}, 2^{nd}, 3^{rd}, . . . 199^{th}, 200^{th}, and delivered to the processing terminal 150 via the connection of the transmission interface 125 and the interface converter 140. Thus, the high-speed image scanning process is all completed.

The disclosed high-speed light sensing element divides the scanned image data and processes it in parallel in order to speed up image processing. Thus, the invention has the advantage of a higher image scanning speed.

Although the present invention has been explained by the embodiments shown in the drawings described above, it should be understood to the ordinary skilled person in the art that the invention is not limited to the embodiments, but rather that various changes or modifications thereof are possible without departing from the spirit of the invention. Accordingly, the scope of the invention shall be determined only by the appended claims and their equivalents.

What is claimed is:

1. A high-speed light sensing element to sense an image light source divided into a plurality of sensing areas and to output a plurality of color signals corresponding to the sensing areas, the high-speed light sensing element comprising:
N light sensing cells, each of which senses one of the sensing areas and outputs corresponding image data;
N color signal processing units, each of which is installed for the associated sensing cell to process the image data and to output corresponding RGB color signals;
N buffers, each of which is installed for the associated color signal processing unit to store the corresponding RGB color signals output from the associated color signal processing unit; and
a synchronous processing unit, which is connected to the N buffers to receive the color signals output from the N buffers and to synchronize the color signals for output.

2. The high-speed light sensing element of claim 1, wherein the light sensing cell is a contact image sensor (CIS).

3. The high-speed light sensing element of claim 1, wherein the light sensing cell is a charge coupled device (CCD).

4. The high-speed light sensing element of claim 1, wherein the light sensing cells are disposed in an array.
